(19) United States
(12) Patent Application Publication
(10) Pub. No.: US 2007/0000778 A1
(43) Pub. Date: Jan. 4, 2007

(54) Multi-parameter sensor with readout circuit

(75) Inventors: Shen-kan Hsiung, Jhongli City (TW); Jung-Chuan Chou, Douliou City (TW); Tai-Ping Sun, Jhongli City (TW); Han-Chou Liao, Fongyuan City (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Chung Yuan Christian University

(21) Appl. No.: 11/171,115

(22) Filed: Jun. 30, 2005

(51) Int. Cl. G01N 27/26

(52) U.S. Cl. 204/419; 204/411

(57) ABSTRACT

The present discloses an ion sensor and its readout circuit. The sensor includes potentiometric, amperometric ion sensors or dual mode electrochemical sensor. The dual mode electrochemical sensors can be measured by the same measurement circuit system. The dual mode sensors are extended gate ion sensitive field effect transistors and amperometric biosensors. The measurement circuit system is adaptable to the different mode sensors.

### FIELD OF THE INVENTION

The present invention relates to an ion sensor and its readout circuit, and more specifically, to the potentiometric, amperometric ion sensors or dual mode electrochemical sensor that can be measured by the same measurement circuit system.

### BACKGROUND OF THE INVENTION

A traditional method employed the glass as an electrode for the ion sensitive measurement. The traditional electrode has some advantages, such as good linearity, good ion selectivity and stability. However, the above-mentioned glass electrode is inconvenient and its applications are confined due to larger size, higher cost and longer response.

Piet Bergveld, IEEE Journal of Transaction Biomedical Engineering, 1970, entitled “Development of an ion-sensitive solid-state device for neurophysiological measurement”, the scheme of detecting ion sensitive by FET is disclosed.

After the removal of the metal on the gate of a typical MOSFET, the FET is then immersed into a solution. The gate oxide layer of the FET is therefore to act as an isolated ion sensitive film. The voltage of the contacting interface of the isolated ion sensitive film varies with the ion concentration of the solution, thereby changing current flow through the channel of the FET to measure the ion concentration of the solution. Therefore, it was called as ISFET.

In 1970 to 1980, the research of the FET ion sensitive device has developed to approach a brand-new level. Whatever on basis theoretical research, critical technique or practical applications research, they have a great of progress and well-developed. For example, W. M. Siu et al., IEEE Journal of Transaction on Electron Device, 1979, entitled “Basic properties of the electrolyte-SiO2—Si system: physical and theoretical aspects”, it disclosed an SiO2—SiN—TaO—Al₂O₃ as the ion sensitive film for a field effect ion sensitive device.

With the field effect ion sensitive device well-developed, the ion specifies that can be detectable by the mechanism are over thirty. The device has a considerable process in the filed of minimization. It can be found in some related patent applications. For example, U.S. Pat. No. 5,833,824 entitled “Dorsal substrate guarded ISFET sensor”; issued Nov. 10, 1998 to Berry W. Benton teaches an ion sensitive device for detecting the ion concentration of the solution.

The FET ion sensitive device has the following advantages over the prior art, minimization, high sensitivity, high input impedance and low output impedance.

An extended gate ion sensitive field effect transistor (EGFET) was developed from the ion sensitive field effect transistor. The concept is disclosed by Sensors and Actuators, pp. 291-298, J. Spiegel et al. published in 1983 entitled “The extended gate chemical sensitive field effect transistor as multi-species microprobe”.

Although the first article that relates to an extended gate ion sensitive field effect transistor was published in 1983, however, the researchers didn't publish the related paper about the subject after 1983. Until 1998, the researchers [Li-Lun Chi, Jung-Chuan Chou, Wen-Yaw Chung, Tai-Ping and Shen-Kan Hsiung,] published the articles that involve the extended gate ion sensitive field effect transistor. Please refer to the article entitled “New structure of ion sensitive field effect transistor”, Proceedings of the biomedical Engineering Society 1988 Annual Symposium, Taiwan, pp. 328-331, December 1998.] Subsequently, the researchers [L. L. Chi, J. C. Chou, W. Y. Chung, T. P. Sun and S. K. Hsiung) presented an improved structure of an extended gate ion sensitive field effect transistor. Please refer to the article entitled “Study on extended gate field effect transistor with tin oxide sensing membrane”, Material Chemistry and Physics, 63, pp. 19-23, 2000. L. L. Chi, L. T. Yin, J. C. Chou, W. Y. Chung, T. P. Sun, K. P. Hsiung and S. K. Hsiung, “Study on separative structure of EnFET to detect acetylcholine”, Sensors and Actuators B, 71, pp. 68-72, 2000.] This material included two parts: one is the sensing structure of SnO₂/ITO/SiO₂, and the other is readout circuit.

U.S. Patent and the U.S. Pat. No. 6,544,193, to Abreu, Marcio Marc, Date of patent Apr. 8, 2003, the patent discloses the noninvasive device to contact the eye of the body, and detect the physical and chemical parameters. Further, the information was transmitted by electromagnetic waves, radio waves, and infrared, and the switch circuit was used to detect the physical and chemical parameters, such as blood components, measurement of systemic and ocular blood flow, measurement of heart rate and respiratory rate, detection of ovulation and drug effects, and the like.

In addition, U.S. Pat. No. 6,703,953 to inventor Maeda, Shigenobu, Ipposhi, Takashi, Kuriyama, Hirotada, Honda, Hiroki, Date of patent Mar. 9, 2004, discloses a polycrystalline semiconductor layer that includes a source, a drain, and a channel region. The thin film transistor (TFT) was dispersed by the cannel region. Furthermore, the sensing device included a potential sensor and a temperature sensor was switched by an encoder circuit, and then the electric signal of semiconductor is transformed into the information.

Furthermore, in the U.S. Patent, U.S. Pat. No. 6,720,712, to Scott et al., the patent discloses a piezoelectric sensor array to obtain different organism information. The sensor array was controlled by multiplexers, and the device can be applied to impendence detection, potential detection, image and Doppler-shift detection. The device is also capable of capturing the image of a fingerprint, and determining the direction and speed of blood that flows in the arteriole and capillary in the finger. Each pixel or a group of pixels can be detected and stored in memory. Therefore, the device can be used as the identify system for public service layer according to the invention.

In view of the above-mentioned, the present invention provides an ion sensor structure and its readout circuit for easy operation, low cost, application to different mode signal of electrochemical sensor.

### SUMMARY OF THE INVENTION

In view of above-mentioned, the object of the present invention is to disclose an ion sensor and its readout circuit that can be measured by the same measurement circuit system.

Another object of the present invention is to disclose a sensor with the advantages that include: (1) good linearity, (2) good ion selectivity, (3) small size (4) high input impedance and low output impedance, (5) fast response, (6) the device with the metal oxide semiconductor field effect transistor scheme. The sensor of the present invention can apply to medicine detection, circuit design and semiconductor fabrication. Besides, the measurement circuit system is suitable to different mode of the sensors.

Another yet object of the present invention is to disclose a sensor, wherein the different measurement modes, such as the amperometric and the potentiometric sensors, are switched by an analog switch. The measurement substances can be determined by the response voltage and current obtained. Furthermore, the measurement circuit system has the advantages of easy operation, low cost, and it is adapted to different mode signal of electrochemical sensors.

The present invention discloses a sensor. The above-mentioned sensor comprises a substrate, a conductive film, a sensing film, an isolating layer and a measurement circuit. The conductive film is formed on the substrate. The sensing film is formed on the conductive film. The isolating layer is covered on partial of the sensing film such that the non-covered region of the sensing film is capable of contacting with a measurement substance. A measurement circuit is coupled to the conductive film to obtain the sensing signals. The measurement circuit comprises a potentiometric measurement circuit, an amperometric measurement circuit or a dual mode measurement circuit. The substrate comprises a glass substrate, a silicon substrate or a ceramic substrate. The sensing film comprises an ammonium ion-sensing membrane, a potassium ion-sensing membrane, a sodium ion-sensing membrane or a calcium ion-sensing membrane. The sensor further comprises a reference electrode coupled to the measurement circuit.

The measurement circuit comprises a first operation amplifier, a resistor, a working electrode, a second operation amplifier, a working voltage and a signal output terminal. The resistor is coupled to a feedback circuit of the first operation amplifier. The working electrode is coupled to a negative electrode of the first operation amplifier. The output terminal of the second operation amplifier is coupled to a counter electrode and a negative electrode of the second operation amplifier is coupled to a reference electrode. The working voltage is coupled to a positive electrode of the second operation amplifier. The signal output terminal is coupled to an output terminal of the first operation amplifier.

The measurement circuit comprises a first operation amplifier, a resistor, a switch, a working electrode, a second operation amplifier, a working voltage and a signal output terminal. The resistor is coupled to a feedback circuit of the first operation amplifier. The switch is coupled to the resistor. The working electrode is coupled to a negative electrode of the first operation amplifier. The output terminal of the second operation amplifier is coupled to a counter electrode and a positive electrode of the second operation amplifier is coupled to a reference electrode. The working voltage is coupled to a negative electrode of the second operation amplifier. The signal output terminal is coupled to an output terminal of the first operation amplifier.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a cross-section of SnO₂/ITO/SiO₂ structure according to the present invention.

FIG. 2 illustrates a diagram of a measurement circuit of a potentiometric sensor according to the present invention.

FIG. 3 illustrates a diagram of three electrodes according to the present invention.

FIG. 4 illustrates a diagram of an adjustable gain of an instrumentation amplifier according to the present invention.

FIG. 5 illustrates a diagram of a measurement circuit of an amperometric sensor according to the present invention.

FIG. 6 illustrates a diagram of a measurement circuit of a dual mode sensor according to the present invention.

FIG. 7 illustrates a diagram of calibration curves of the potentiometric pH sensor measured by the dual mode sensor readout circuit according to the present invention.

FIG. 8 illustrates a diagram of calibration curves of the potentiometric sodium ion sensor measured by the dual mode sensor readout circuit according to the present invention.

FIG. 9 illustrates a diagram of calibration curves of the amperometric uric acid sensor measured by the cyclic voltammetry according to the present invention.

FIG. 10 illustrates a diagram of calibration curves of the amperometric uric acid sensor measured by the dual mode sensor readout circuit according to the present invention.

### DETAILED DESCRIPTION OF THE PREFERRED EMBODIMENT

Referring now to the drawings and the following description wherein the showings and description are for the purpose of illustrating the preferred embodiments of the present invention only, and not for the purpose of limiting the same.

Please refer to FIG. 1, it illustrates a cross-section of ion sensor structure according to the present invention. The sensor structure comprises a substrate, such as a glass substrate 11. A conductive film 12 is laminated on the glass substrate 11. The conductive film 12 is well known in the art, such as an ITO (indium tin oxide). Besides, a silicon substrate or a ceramic substrate may be used to replace the glass substrate 11. A sensing film 13 is formed on the conductive film 12. The sensing film 13 may be a SnOₓ film formed on the conductive film 12 by a RF sputtering method of semiconductor manufacturing process.

In one embodiment, the SnOₓ film 13 is formed on the ITO 12 laminated on the glass substrate 11 by sputtering process. The pressure parameters for the process is about from 20 mTorr to 200 mTorr, the power of the desposition is greater than 10 watt power, preferably 50 watt and the substrate temperature is higher than zero degree centigrade. The conductive film 12 may be made of a mixture of SnOₓ with SnO₂.

Subsequently, an isolating layer 14 is encapsulated on partial electrode of the SnO₂/ITO/SiO₂ structure. The material of the isolating layer 14 comprises resin, compound, epoxy, silicone, silicone rubber, silicone resin, elastic PU, porous PU, acrylic rubber, blue tape or UV tape, and is covered on partial circumference of the SnO₂/ITO/SiO₂ structure such that non-covered isolating layer 14 region of the sensor is capable of contacting with a measurement substance to measure.

A wire 15 is connected with the SnOₓ film 13 or the ITO 12 so as to connect to a measurement circuit. In one embodiment, a sensor of the present invention is a pH-value sensor. Furthermore, the sensing film 13 may be added different sensing layer to act different-function sensor: ammonium ion-sensing membrane, a potassium ion-sensing membrane, a sodium ion-sensing membrane or a calcium ion-sensing membrane to measure a different ion concentration. The ammonium ion-sensing membrane is made from the mixture solution including Nonactin, DOS and PVC. The potassium ion-sensing membrane is made form the solution including Valinomycin, DOS and PVC. The sodium ion-sensing membrane is made from the mixture of ETH 157, DOS and PVC. The calcium ion-sensing membrane is made from the mixed solution of ETH 129, DOS and PVC. The Nonactin, valinomycin, ETH 157, and ETH 129 are kinds of ionophore. The above-mentioned ion-sensing (such as ammonium ion-sensing, potassium ion-sensing, sodium ion-sensing or calcium ion-sensing) mixture solution drops on the SnOₓ film 13 to form an ion sensor after removing water. Sensing membranes and its composition of the mixture solution of the present invention are listed as follows:

| Sensor | Sensing membrane |
|---|---|
| pH sensor | pH sensing membrane |
| | (SnOₓ) |
| Ammonium sensor | Ammonium ion-sensing membrane |
| | (Nonactin + DOS + PVC) |
| Potassium sensor | Potassium ion-sensing membrane |
| | (Valinomycin + DOS + PVC) |
| Sodium sensor | Sodium ion-sensing membrane |
| | (ETH 157 + DOS + PVC) |
| Calcium sensor | Calcium ion-sensing membrane |
| | (ETH 129 + DOS + PVC) |

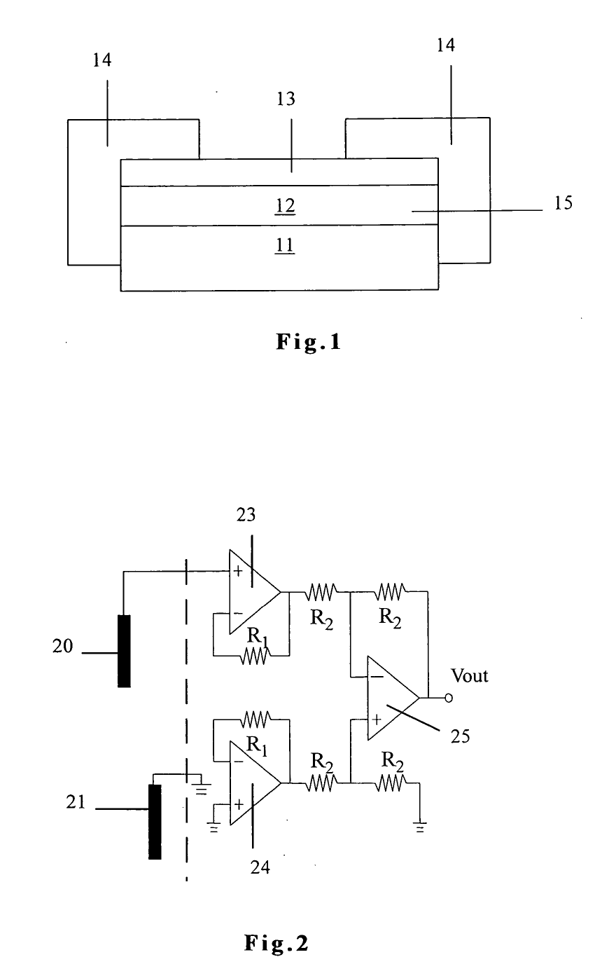

Please refer to FIG. 2, it illustrates a diagram of a measurement circuit of a potential type sensor according to the present invention. The measurement circuit comprises three operation amplifiers 23, 24 and 25, a plurality of resistors R1 and R2 to constitute an amplifying circuit. A sensor 20 with the SnO₂/ITO/SiO₂ structure of the present invention, such as pH sensor or Sodium sensor, is connected to a positive input terminal of the operation amplifier 23. A reference electrode 21 made of Ag or AgCl is connected to the positive input terminal of the operation amplifiers 24. The sensor 20 and the reference electrode 21 are simultaneously immersed in a under test solution for measurement. In one embodiment, the measurement circuit is an amplifying circuit, such as an instrumentation amplifier or a commercial specification integrated circuit LT1167. The voltage output terminal (V output) of the amplifying circuit may obtain a voltage signal according to the ion concentration in the solution.

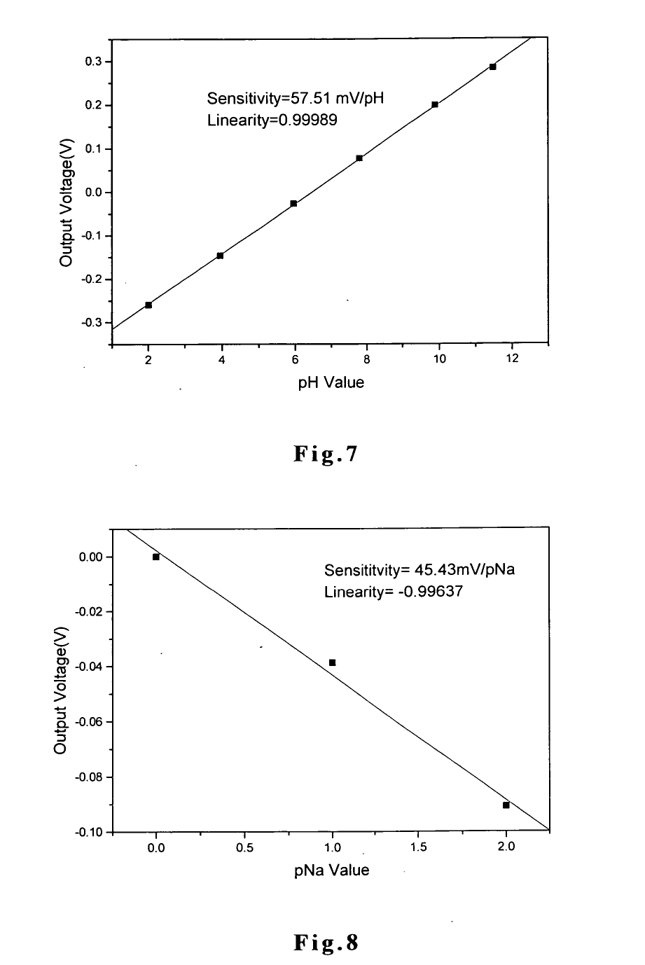

Please refer to FIG. 7, it illustrates a diagram of calibration curves of the potential type pH sensor according to the present invention. The electrode of the present invention is accompany with the measurement circuit of the above embodiment to practice a measurement and utilize a signal readout instrument (such as meter, oscilloscope) for reading out a voltage signal from the voltage output terminal of the operation amplifiers 25. FIG. 7 shows a pH value of different ion concentration of standard acid/base solution vs. the corresponding output voltage. In FIG. 7, the transverse coordinate axis represents hydrogen ion concentration indicated by pH value, and the longitudinal axis represents a readout voltage value indicated by Volt (V). According to FIG. 7, the measurement range of the hydrogen ion concentration is between pH 2 and pH 12. The sensitivity is 57.51 mV/pH and linearity is 0.99989. The acid/base sensor of this embodiment benefits an excellent linearity.

Similarly, the measurement electrode of the present invention can be utilized to measure sodium ion concentration, as shown in FIG. 8. In FIG. 8, the transverse coordinate axis represents sodium ion concentration indicated by pNa value, and the longitudinal axis represents a readout voltage value indicated by Volt (V). According to FIG. 8, the measurement range of the sodium ion concentration is between pNa 2 and pNa 0.1. The sensitivity is 45.53 mV/pNa and linearity is 0.99637. The system of this embodiment has an excellent linearity of the measurement of the sodium ion concentration.

Please refer to FIG. 4, it illustrates a diagram of an adjustable gain of an instrumentation amplifier according to the present invention. The instrumentation amplifier comprises a LM741 or a LT1167 which are commercial specification IC. The instrumentation amplifier is an amplifying circuit constituted of three operation amplifiers 40, 41, 42, and a plurality of resistors R1 and R2. Besides, a resistor Rg is an adjustable gain resistor. A voltage signal of the output terminal divided by a voltage signal of the input terminal equals the gain of the instrumentation amplifier, as shown in FIG. 4, gain (Δ)=Vout/Vin=(1+2R1/Rg). In one embodiment, the resistor Rg is 50Ω, and its gain is 60 dB, for instance.

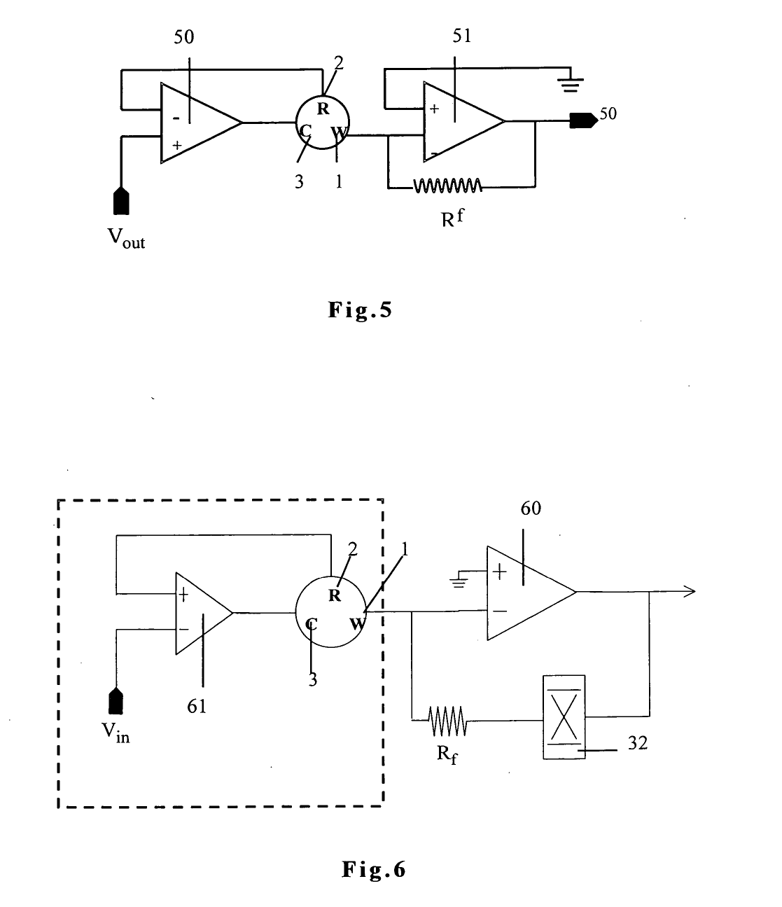

Please refer to FIG. 5, it illustrates a diagram of a measurement circuit of an amperometric sensor according to the present invention. The commercial IC LT1167 is incorporated into the circuits to act the operation amplifier 51. The 50Ω resistor Rg of the FIG. 4 may be added into the circuits to adjust the instrumentation amplifier for obtaining the gain 60 dB. Another operation amplifier 50 can be a commercial IC, the type name is LM741. As shown in FIG. 5, a working electrode, W, 1 may be connected to an ammonium sensor. R is a reference electrode 2 connected to the negative input of the operation amplifier 50, and C represents a counter electrode 3 connected to the output of the operation amplifier 50. Material of a reference electrode 2 and a counter electrode 3 are Ag or AgCl. A signal output terminal of the operation amplifier 51 may obtain a voltage signal by using a Cyclic Voltammetry (CV).

The positive input terminal of the operation amplifier 51 is grounded and the negative input terminal of the operation amplifier 51 is connected to the working electrode 1 and a 10Ω resistor Rf. Another terminal of the resistor Rf is connected to the output of the operation amplifier 51. A pre-determined voltage 200 mV is applied to the positive input of the operation amplifier 50 so as to provide an over-potential for the working electrode 1, thereby creating an electro-chemical reaction. A pre-determined voltage 200 mV is biased between the reference electrode 2 and the working electrode 1. According to the FIG. 5, the circuit just uses two operation amplifiers 50, 51 and one resistor Rf to obtain signal accurately.

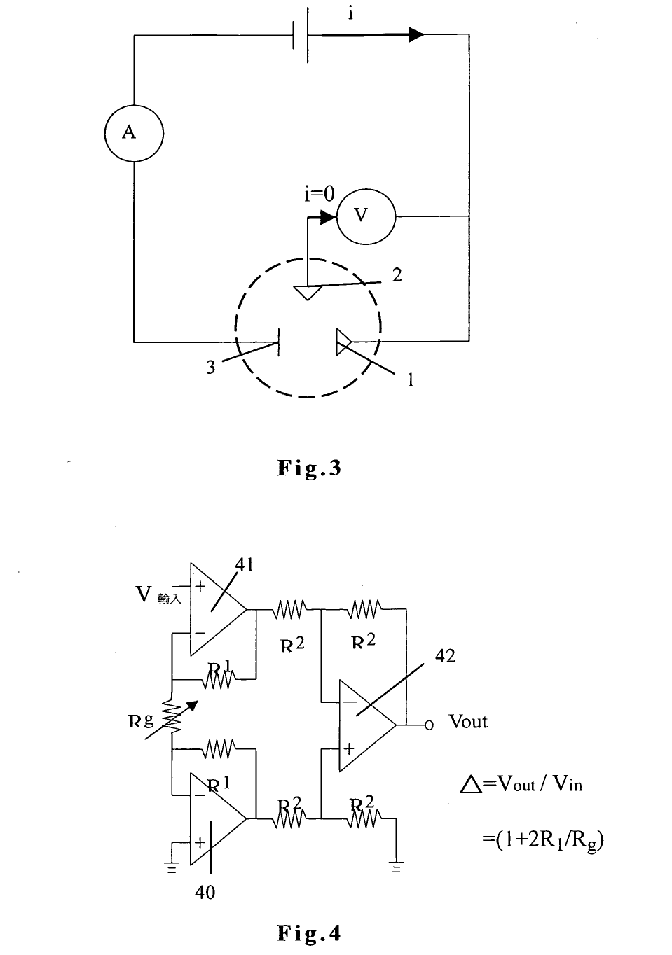

Please refer to FIG. 3, it illustrates a diagram of three electrodes according to the present invention. The three electrodes are a working electrode 1, a counter electrode 3 and a reference electrode 2. The potential between the working electrode 1 and the reference electrode 2 may be determined by a voltmeter of the FIG. 3. However, the counter electrode 3 and the reference electrode 2 in the structure of the three electrodes constitute a current circuit, and the current between the counter electrode 3 and the reference electrode 2 may be determined by an ammeter.

The output of the operation amplifier 50 is connected to the counter electrode 3. The above-mentioned sensor and the reference electrode 2 may be employed to measure the composition and concentration of the pre-determined solution. The counter electrode 3 is used to prevent the working electrode 1 and the reference electrode 2 from a potential drop at the reference electrode 2 owing to the current created by the working electrode 1 such that the reference potential of the reference electrode 2 isn't accurate. Accordingly, the present invention must use the structure of three electrodes of the FIG. 3.

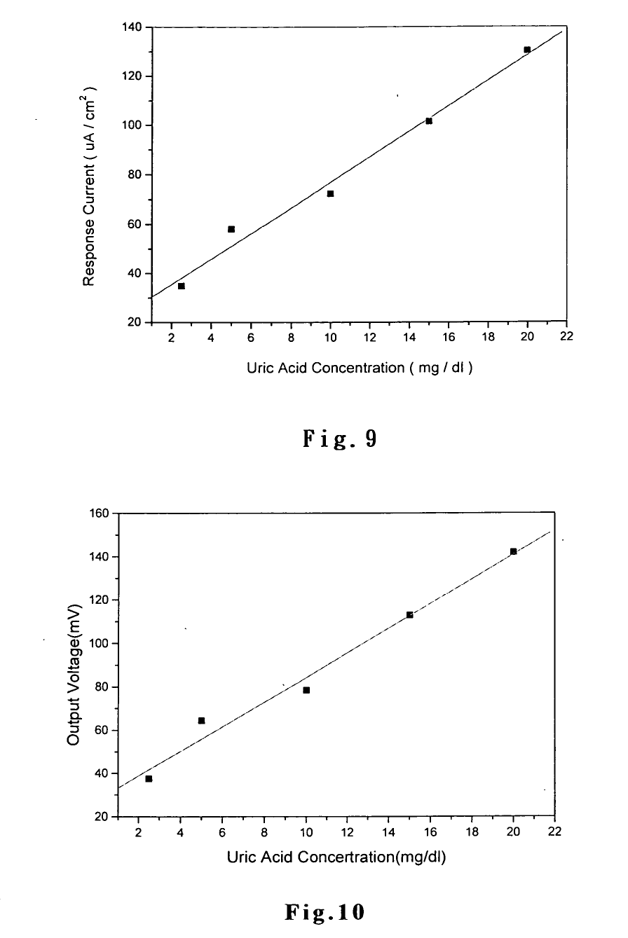

Please refer to FIG. 9, it illustrates the measurement result of the amperometric uric acid. In FIG. 9, the transverse coordinate axis represents uric acid concentration indicated by mg/dl, and the longitudinal axis represents a response current indicated by μA/cm². The over-potential is 200 mV, and the measurement range is between 2.5 mg/dl and 20 mg/dl.

Please refer to FIG. 6, it illustrates the measurement circuit of a dual mode sensor. The present invention uses a commercial IC a LT1167 for the operation amplifier 60. The 50Ω resistor Rg of the FIG. 4 may be added to adjust the instrumentation amplifier getting the gain 60 dB. The operation amplifier 61 is a commercial IC LM741. Material of the reference electrode 2 and the counter electrode 3 are Ag or AgCl.

The positive input terminal of the operation amplifier 60 is grounded and the negative input terminal of the operation amplifier 60 is connected to the working electrode 1 and a 10Ω resistor Rf, a switch 32, respectively. Another terminal of the switch 32 is connected to the output of the operation amplifier 60. A predetermined voltage 200 mV is applied to the positive input of the operation amplifier 61 so as to provide the over-potential (Vₛₑₜ) for the working electrode 1, thereby creating an electro-chemical reaction. A determined voltage between the reference electrode 2 and the working electrode 1 is around 200 mV. The switch 32 is an analog switch.

The measurement circuit of the dual mode sensor combines a potentiometric sensor and an amperometric sensor switching by the analog switch 32. The measurement circuit comprises two operation amplifiers 60, 61 one resistor Rf and one analog switch 32. In measuring the potentiometric sensor shown as FIG. 2, the analog switch 32 is open, therefore the circuit of the left block is not use. Furthermore, the operation amplifier 60 is grounded, and the positive input of the operation amplifier 60 connects a sensor to obtain signals. The measurement range is between pH2 and pH12, and the experimental result is shown in FIG. 7. The sensitivity is 57.51 mV/pH and linearity is 0.99989. The measurement range of the sodium ion concentration is between pNa 2 and pNa 0.1 shown as FIG. 8. The sensitivity is 45.53 mV/pNa and linearity is 0.99637.

On the other hand, in measuring the amperometric uric acid sensor are shown in FIG. 5, the analog switch 32 is close, and all measurement circuits are used. In addition, the response current of the working electrode 1 is obtained by the transimpedance amplifier. FIG. 10 shows the measurement result of the amperometric uric acid sensor used in the readout circuit of the dual sensor. The over-potential (Vₛₑₜ) is supplied with a potential around 200 mV, and the measurement range is from 2.5 mg/dl to 20 mg/dl. Comparing the measurement result of the FIG. 10 with FIG. 9, both of the measurements are good.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A sensor, comprising:
a substrate;
a conductive film formed on said substrate;
a sensing film formed on said conductive film;
an isolating layer covered on partial of said sensing film such that non-covered region of said sensing film is capable of contacting with a measurement substance; and
a measurement circuit coupled to said conductive film to obtain the sensing signals.

2. The sensor of claim 1, wherein said measurement circuit comprises a potentiometric measurement circuit, an amperometric measurement circuit or a dual mode measurement circuit.

3. The sensor of claim 1, wherein said substrate comprises a glass substrate, a silicon substrate or a ceramic substrate.

4. The sensor of claim 1, wherein said sensing film comprises an ammonium ion-sensing membrane, a potassium ion-sensing membrane, a sodium ion-sensing membrane or a calcium ion-sensing membrane.

5. The sensor of claim 1, wherein said conductive film is formed by a sputtering method.

6. The sensor of claim 5, wherein process parameters of said sputtering comprise a power greater than 10 watt, a temperature higher than zero centigrade degree and pressure from about 20 mTorr to 200 mTorr.

7. The sensor of claim 1, wherein material of said isolating layer comprises resin, compound, epoxy, silicone, silicone rubber, silicone resin, elastic PU, porous PU, acrylic rubber, blue tape or UV tape.

8. The sensor of claim 1, wherein said conductive film comprises ITO (indium tin oxide).

9. The sensor of claim 1, wherein said sensing film comprises SnO₂.

10. The sensor of claim 1, wherein said sensor comprises pH sensor, ammonium sensor, potassium sensor, sodium sensor or calcium sensor.

11. The sensor of claim 1, further comprising a reference electrode coupled to said measurement circuit.

12. The sensor of claim 1, wherein said measurement circuit comprises:
a first operation amplifier;
a resistor coupled to a feedback circuit of said first operation amplifier;
a working electrode coupled to a negative electrode of said first operation amplifier;
a second operation amplifier, wherein an output terminal of said second operation amplifier is coupled to a counter electrode and a negative electrode of said second operation amplifier is coupled to a reference electrode;
a working voltage coupled to a positive electrode of said second operation amplifier; and
a signal output terminal coupled to an output terminal of said first operation amplifier.

13. The sensor of claim 12, wherein material of said reference electrode and said counter electrode comprises Ag or AgCl.

14. The sensor of claim 1, wherein said measurement circuit comprises an instrumentation amplifier.

15. The sensor of claim 14, wherein said measurement circuit comprises an adjustable resistor coupled to said instrumentation amplifier.

16. The sensor of claim 1, wherein said measurement circuit comprises:
a first operation amplifier;
a resistor coupled to a feedback circuit of said first operation amplifier;
a switch coupled to said resistor;
a working electrode coupled to a negative electrode of said first operation amplifier;
a second operation amplifier, wherein an output terminal of said second operation amplifier is coupled to a counter electrode and a positive electrode of said second operation amplifier is coupled to a reference electrode;
a working voltage coupled to a negative electrode of said second operation amplifier; and
a signal output terminal coupled to an output terminal of said first operation amplifier.
